(19) United States
(12) Patent Application Publication
(10) Pub. No.: US 2007/0175712 A1
(43) Pub. Date: Aug. 2, 2007

(54) SPRING BRAKE FOR AN INDUSTRIAL TRUCK

(75) Inventors: Thomas Hargarten, Sulm (DE); Jan Herschel, Bad Oldesloe (DE); Ansgar Kuckoff, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Jungheinrich Aktiengesellschaft, Hamburg (DE)

(21) Appl. No.: 11/627,154

(22) Filed: Jan. 25, 2007

(30) Foreign Application Priority Data
Jan. 28, 2006 (DE) 10 2006 004 065.1

(51) Int. Cl. F16D 65/36

(52) U.S. Cl. 188/156

(57) ABSTRACT

Spring brake for an industrial truck with a brake disc, which is splinedly mounted on a rotatable motor shaft, a brake magnet disposed in a vehicle-fixed brake housing, a splined axially movable pressure plate between brake disc and brake magnet, which is pie-tensioned against the brake disc by a spring arrangement, and a device for monitoring the switch status of the spring brake, characterised in that a proximity switch is fixed on the brake housing, an initiator for the proximity switch is connected with the pressure plate and the hysteresis for the proximity switch is smaller than the minimal travel path of the pressure plate.

### CROSS-REFERENCE TO RELATED APPLICATIONS

Not applicable,

### STATEMENT REGARDING FEDERALLY SPONSORED RESEARCH

Not applicable.

### BACKGROUND OF THE INVENTION

Such spring brakes are usually installed in the housing of a motor in an industrial truck or set up on a motor housing. A brake disc is rotatingly driven by the motor shaft, whereas an electromagnet fixed in the brake housing is stationary and acts on a pressure plate between brake disc and electromagnet. The pressure plate is pre-tensioned against the brake disc with the aid of a pre-loaded spring. Thus, the braking condition is established when the electromagnet is not energised. When the brake is to be lifted, the magnet is actuated and pulls the pressure plate towards him, so that the brake disc can rotate freely.

Such a spring brake is used as service brake system for industrial trucks. The triggering takes place via the travel steering, for instance. Furthermore, the vehicle can be controlled and braked down with the aid of the spring brake in the case of a malfunction of a steering. This function is designated as an emergency stop and can be initiated in the various security checks of the steerings. Travel permission takes place when the vehicle is switched on and a self-test is performed with a positive result.

In order to perform the various functions in a safe way, it is required to sense the actual switch status of the magnetic brake and to send back a corresponding switching signal to the steering.

It is known to realise the switch status of such a spring brake with the aid of a micro switch. From DE 195 48 520 B4, the entire contents of which is incorporated herein by reference, it is also known to measure an electric signal which depends on the thickness of the air gap between pressure plate and electromagnet. For this purpose, a periodically changing voltage is applied to the electromagnet, which does not lead to actuation of the pressure plate, however. Thereafter, the amplitude of the periodically changing current is detected, which is proportional to the dimension of the air gap.

From DE 101 49 604, the entire contents of which is incorporated herein by reference, it is also known to interpret the derivative in time of the voltage and/or the current on the coil of the electromagnet. With the aid of this method, not only the switch status of the brake is detected, but also the magnitude of the air gap, which is also possible with the means of the spring brake described above.

In fact, the mentioned means for establishing the switch status of a spring brake do not require additional mechanical measures, on the other hand, electronic means are required in order to apply a desired voltage course on the electromagnet and to analyse the resulting current course. Micro switches have the disadvantage that sensing takes place by contact and is therefore not free from wear. When used in cold warehouses, the micro switch may freeze fast and therefore provide an erroneous signal.

The present invention is based on the objective to provide a spring brake for industrial trucks in which the switch status of the spring brake can be detected by simple and safe means.

### BRIEF SUMMARY OF THE INVENTION

In the invention, a proximity switch is installed in the brake housing. An initiator for the proximity switch is connected with the pressure disc of the spring brake. The hysteresis for the inductive proximity switch is smaller than the minimum travel of the pressure plate

In the invention, it has been recognised that it is sufficient to establish whether the pressure disc is picked up by the electromagnet or whether it is pressed against the brake disc by the pre-loaded spring. For this purpose, the use of a simple inductive proximity switch is sufficient, the output signal of which makes a yes/no-decision possible. The proximity switch is actuated by a pin, connected with the pressure plate, which approaches the proximity switch more or less according to the position of the pressure plate. Naturally, an inductive proximity switch has a certain hysteresis. According to the present invention, this hysteresis is smaller than the minimum travel of the pressure plate. Thus, a switch-over of the proximity switch is achieved in every case when the pressure plate is moved from one end of the travel path to the other one.

The construction measures for the invention are minimal. Preferably, the initiator, which may be realised as a pin, is adjustable in its axial position, in order to trim it with respect to the proximity switch.

According to one embodiment, the cupped brake housing has a recess on the girth, in which the proximity switch is installed. Through this, the proximity switch does not exceed the outer dimensions of the brake or the brake housing, respectively. In this case, the initiator pin extends through the bottom of the recess.

### BRIEF DESCRIPTION OF THE SEVERAL VIEWS OF THE DRAWINGS

In the following, the invention is explained in more detail by means of realisation examples, represented in drawings.

FIG. 1 shows a section through a typical spring brake.

FIG. 2 shows a part of the brake housing of the spring brake according to FIG. 1, in a perspective view.

FIG. 3 shows the switching path of a proximity switch according to FIG. 2

FIG. 4 shows the brake housing according to FIG. 1 in a perspective view, with another embodiment of a proximity switch or a placement, respectively.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

The brake spring according to FIG. 1 has a brake housing 10, in which an electromagnet 12 is accommodated. The brake housing 10 is attached on a plate 14, which is vehicle-fixed. It is dealt with an industrial truck, and the brake serves to slow down a shaft 16, which is a part of a not shown motor of the industrial truck. On the shaft 16 sits a brake disc 18 and rotates with it, however, it is axially fixed. On the brake disc, friction pads 20 and 22, respectively, sit on opposite sides. Between the brake magnet 12 and the brake disc 18, a pressure plate 24 is disposed, which is arranged to be axially movable in a restricted extent, but being splined, however. The pressure plate is pre-tensioned against the brake disc 18 by several pre-loaded springs 28. In this case, there is a gap s between the abutting side of the brake magnet 12 and the brake housing 10, respectively. This gap or path s is traveled by the pressure plate 24 when it is pulled by the brake magnet 12 towards the same. This is the case when the brake magnet 12 is energised.

The brake housing 10 is fixed on the plate 14 with the aid of several bolts, one of which is represented at 30. With the aid of these bolts 30, the distance between the plate 14 and the brake housing 10 can be adjusted. When the friction pads 20, 22 do not have wear, the travel s is minimal. At increasing wear, the travel becomes greater according to the wear-away of the friction pads 20, 22.

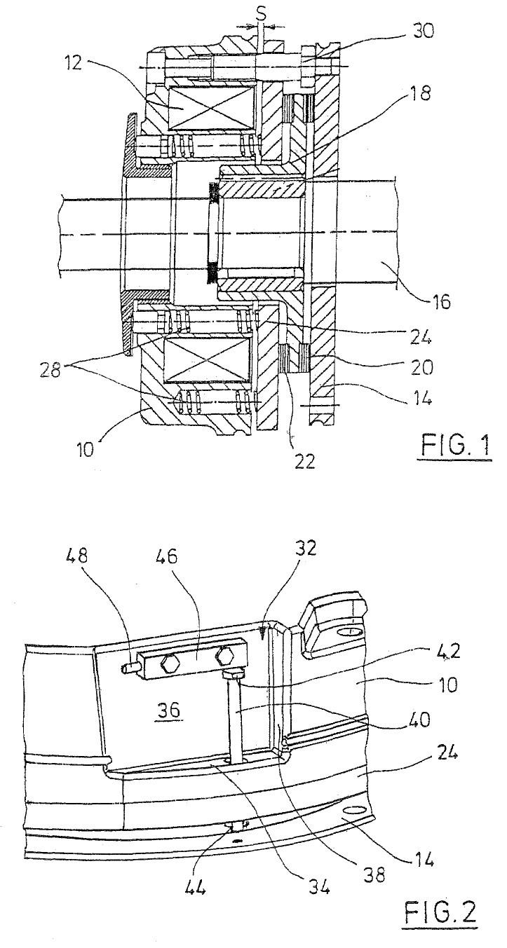

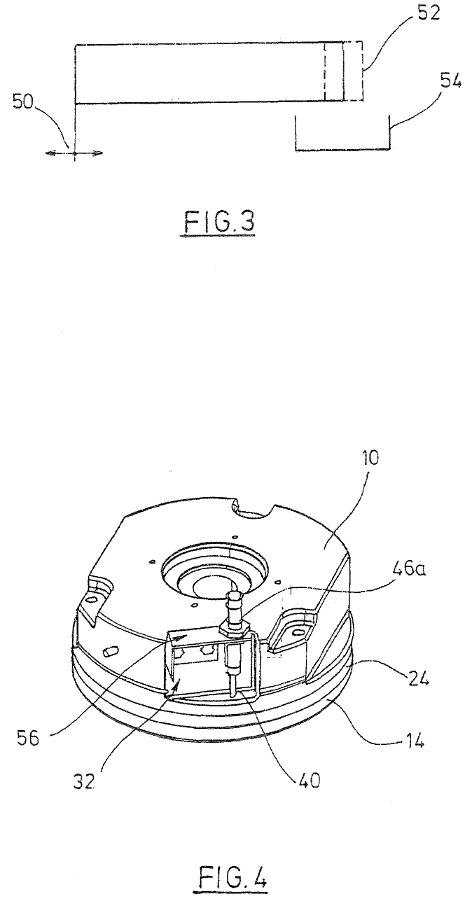

As can be recognised from FIGS. 1 and 2, the brake housing 10 is cupped. In FIG. 2, it can be further recognised that a recess 32 is formed in the sidewall of the brake housing 10, with a bottom 34, a first sidewall 36 and a second sidewall 38. The bottom 43 is approximately trigonal, so that the contour of recess 32 results from this. A pin 40 extends through the bottom 34, which has a head 42. The pin is screwed together with the pressure plate 24, a nut for this purpose being recognizable at 44. Thus, the pin moves upon travel of the pressure plate 24. On the wall 36, a proximity switch (not recognizable) is accommodated in an elongated housing 46, which is connected to a steering for the industrial truck via a line 48. The head 42 of the pin 40 has a minimum distance when maximally approaching the proximity switch, of one millimetre for instance. The proximity switch is opened or closed depending on the position of the head 42. In FIG. 3, the switching path of the proximity switch is shown, wherein the shift of the proximity switch with respect to the pin 40 or its head 42 is intended to be indicated by the opposing arrows. The proximity switch has a hysteresis, which has to taken into account. It is indicated by the dashed lines at 52. At 54, the minimum travel path of the shown brake is represented. As already mentioned, the same can become only greater with further operation of the industrial truck. As can be recognised, the minimum travel path 54 is greater than the hysteresis 52, so that even at minimum travel the proximity switch has differing positions, depending on whether the brake magnet picks up the pressure plate or whether the pre-loaded springs press it against the brake disc 18.

The construction realisation according to FIG. 2 has the advantage that the switching means for detecting the status of the spring brake do not increase the dimensions of the brake.

In FIG. 4, the brake housing 10 is shown, which is similar to the brake housing 10 in FIG. 1 or 2, respectively. However, one recognises a modified proximity switch 46a. It is realised to be pipe-shaped and is attached on an angular plate part 56, which is screwed on the wall 36 of the recess 32 with the aid of screws. The proximity switch 46a is held fast on opposing sides of an upper plate portion, which is provided with a corresponding bore, with the aid of nuts. The pin 40 may be fixedly connected with the pressure plate 24 by weldings or the like, for instance. Trimming takes place with the aid of the proximity switch 46 and related nuts.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto,

What is claimed is:

1. Spring brake for an industrial truck with a brake disc, which is splinedly mounted on a rotatable motor shaft, a brake magnet disposed in a vehicle-fixed brake housing, a splined axially movable pressure plate between brake disc and brake magnet, which is pre-tensioned against the brake disc by a spring arrangement, and a device for monitoring the switch status of the spring brake, characterised in that a proximity switch (46, 46a) is fixed on the brake housing (10), an initiator (40) for the proximity switch (46, 46a) is connected with the pressure plate (24) and the hysteresis for the proximity switch (46, 46a) is smaller than the minimum travel path of the pressure plate (24).

2. Spring brake according to claim 1, characterised in that the initiator is a metal pin (40) which is connected with the pressure plate (24), preferably via a threaded connection.

3. Spring brake according to claim 2, characterised in that the axial position of the pin (40) is adjustable.

4. Spring brake according to claim 2, characterised in that a cupped brake housing (10) has a recess (32) on the girth, the proximity switch (46) is arranged in the recess (32), and the pin (40) extends through the bottom (34) of the recess towards the proximity switch (46).

5. Spring brake according to claim 1, characterised in that the switching distance of the proximity switch (46, 46a) is greater than the minimum travel path of the pressure plate (24) that can be sensed.
